(19) United States
(12) Patent Application Publication
(10) Pub. No.: US 2008/0170740 A1
(43) Pub. Date: Jul. 17, 2008

(54) SELF-CONTAINED DUAL EARBUD OR EARPHONE SYSTEM AND USES THEREOF

(75) Inventor: Christopher Gantz, Northbrook, IL (US)

Correspondence Address: Joseph A. Fuchs;Rockey, Depke & Lyons, LLC, 233 S. Wacker Drive, Suite 5450, Sears Tower, Chicago, IL, 60606-6306, US

(73) Assignee: SYNC1, Northbrook, IL (US)

(21) Appl. No.: 11/970,267

(22) Filed: Jan. 7, 2008

Related U.S. Application Data
(60) Provisional application No. 60/878,826, filed on Jan. 5, 2007.

(51) Int. Cl. H04R 25/00

(52) U.S. Cl. 381/380

(57) ABSTRACT

The present invention provides an earphone system having a first primary earphone having a portion for contacting a portion of an ear of a user; a first secondary earphone releasably connected to the primary earphone to define a first earphone assembly, the first secondary earphone having a portion for contacting a portion of an ear of a user; and a member for electrically connecting the primary earphone and the secondary earphone to a source of an electrical signal representative of an audible sound.

### CROSS-REFERENCE TO RELATED APPLICATION

This Application claims priority to U.S. Provisional Patent Application No. 60/878,826, filed on Jan. 5, 2007, the disclosure of which is incorporated in its entirety by reference herein and made a part hereof.

### FEDERALLY SPONSORED RESEARCH OR DEVELOPMENT

Not Applicable

### BACKGROUND OF THE INVENTION

1. Technical Field

The present invention provides an earphone system having an earphone assembly having two earphones nested together when in a docked position and resembling a single earphone. The earphone system can be connected to a signal source through a corded connection or a wireless connection.

2. Background Art

Audio devices and communication devices are widely used throughout the industrialized nations of the World. Many of these devices are portable and provide an electrical signal representative of audible sounds to the ear or ears of a user through earphones. The audible sounds come from numerous sources such as telephones, hand-held radios, streaming content from the Internet, radio broadcasts, television broadcasts, stored information such as music, podcasts or other forms of entertainment and instructional programming and other sources too numerous to list here. One drawback with conventional earphones is that they are not easily shared by two users for simultaneous enjoyment of source material. Audio devices, in many instances, have specific, non-standard electrical output ports that are not compatible with all of the variety of styles of plugs found on the types of earphones on the market today. Thus, one person's earphones may not be useable with the audio device that holds the desired audio content to be shared. Further, because most portable audio devices have only a single electrical output port, it is necessary to have a signal splitter compatible with the audio device to allow for the use of two sets of earphones. In many instances either a second set of compatible earphones or an appropriate signal splitter are not available, thus, making simultaneous enjoyment of an audio source by two users difficult.

A second drawback with mono-bud headphones which are widely used with cellular telephones is that the mono-buds do not allow a user to listen in binaural or stereo. With an ever increasing variety of source material accessible on cell phones it is desirable to provide a headphone system that provides the option to convert a mono-bud system into a dual bud system for binaural and stereo listening.

### BRIEF DESCRIPTION OF THE DRAWINGS

FIG. 1 is perspective view of a self-contained dual bud headphone system;

FIG. 2 is a side view of another embodiment of a self-contained dual bud headphone system;

FIG. 3 is a perspective view of the self-contained dual bud headphone system of FIG. 1 with a secondary earbud undocked from a primary earbud;

FIG. 4 is a perspective view of the self-contained dual bud headphone system of FIG. 2 with a secondary earbud undocked from a primary earbud;

FIG. 5 is a diagrammatic view of a self-contained dual bud headphone system of FIG. 1 in an undocked position with two primary earbuds positioned for use by one or a first couple of people and two secondary earbuds for use with a second person or a first or second couple of people, the headphone system being electrically connected through an optional cord to an MP3 player;

FIG. 6 is an expanded view of a switch shown in FIG. 5 for switching between a first position for use by a single person and a second position for simultaneous use by two or more people;

FIG. 7 is a diagrammatic view of a self-contained dual bud headphone system of FIG. 1 in an undocked position with a first set of a first primary earbud and a first secondary earbud positioned for use by one person or a first couple of people and a second set of a second primary earbud and a second secondary earbud for use with a second person or a first or second couple of people, the headphone system being electrically connected through an optional cord to an MP3 player;

FIGS. 8a,b,c are respectively a diagrammatic view of a wireless dual bud headphone system with a wireless connection between a primary earbud and a signal source, shown in the docked position (FIG. 8a) and in the undocked position with the secondary earbud receiving a signal either from the primary earbud (FIG. 8b) or both the primary and the secondary earbuds independently receive a signal from the audio source (FIG. 8c);

FIGS. 9a,b are respectively a diagrammatic view of a wireless dual bud headphone system in a docked and an undocked position, having a wireless connection between the primary earbud and a signal source and a corded electrical connection between the primary earbud and the secondary earbud; and

FIGS. 10a,b are respectively a diagrammatic view of a wireless dual bud headphone system in a docked and an undocked position, having a corded electrical connection between the primary earbud and an audio source and a wireless connection between the primary earbud and the secondary earbud.

These and other aspects and attributes of the present invention will be discussed with reference to the following drawings and accompanying specification

### SUMMARY OF THE INVENTION

The present invention provides an earphone system having a first primary earphone having a portion for contacting a portion of an ear of a user; a first secondary earphone releasably connected to the primary earphone to define a first earphone assembly, the first secondary earphone having a portion for contacting a portion of an ear of a user; and a member for electrically connecting the primary earphone and the secondary earphone to a source of an electrical signal representative of an audible sound. The member for connecting the earphone assembly to the source of the electrical signal can utilize either corded, wireless or a combination of these two connectologies.

### DETAILED DESCRIPTION OF THE INVENTION

While this invention is susceptible of embodiment in many different forms, there is shown in the drawings, and will be described herein in detail, specific embodiments thereof with the understanding that the present disclosure is to be considered as an exemplification of the principles of the invention and is not intended to limit the invention to the specific embodiments illustrated.

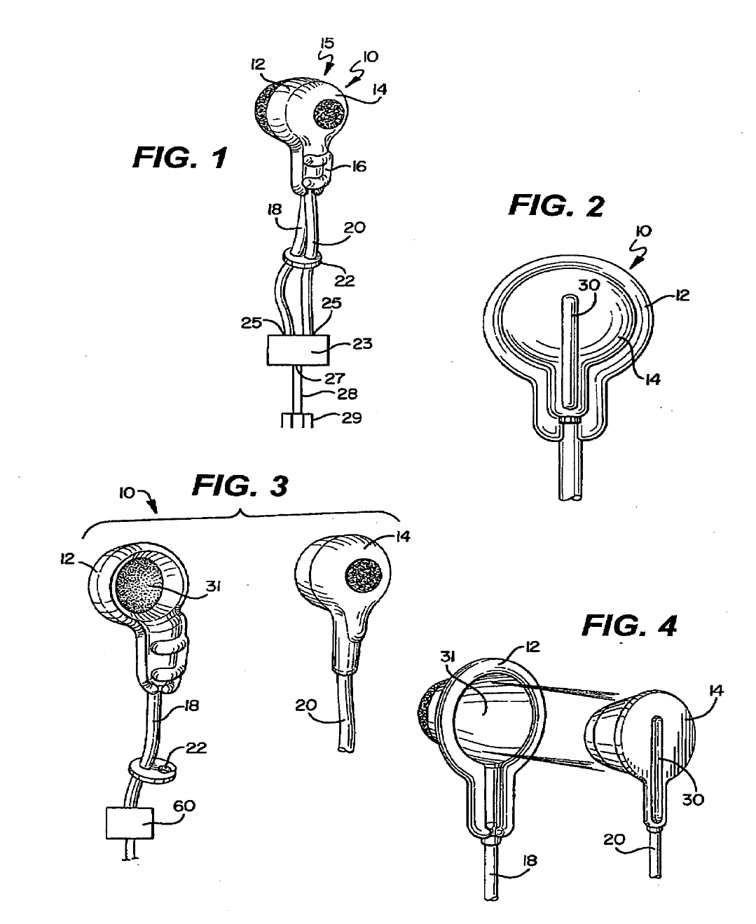

FIG. 1 shows a self-contained dual bud headphone system 10 shown in a docked 10 position having a primary earbud 12, a secondary earbud 14 attached to the primary earbud by an attaching member 16, a first and second cord 18 and 20 for supplying the primary earbud and the secondary earbud with an electric signal and a cord minder member 22 for connecting the first cord to the second cord when the system 10 is in the docked position. The first cord and the second cord are electrically coupled together by a connector 23 having two output ports 25 and one input port 27. The first and second cords are electrically coupled to one of each of the output ports 25 and a third cord 28 has a first end electrically coupled to the input port 27 and a second end terminating in a plug 29 for docking to the audio source. Any one of the cords 18, 20 or 28 could be replaced with a wireless connection.

While in the docked position, the primary earbud 12 and secondary earbud 14 appear to be a single earbud and define a first earbud assembly 15. In a preferred form of the invention the primary earbud 12 and the secondary earbud 14 will be releasably connected together so that the system can be easily moved between a docked position and an undocked position by a user of the earbud system. While the attaching member 16 is shown connected to the primary earbud 12, and forming a part thereof, to define a unitary structure it is contemplated having the attaching member 16 connected to the secondary earbud 14 or forming a part thereof, or the attaching member 16 could be a separate piece from the primary and secondary earbuds.

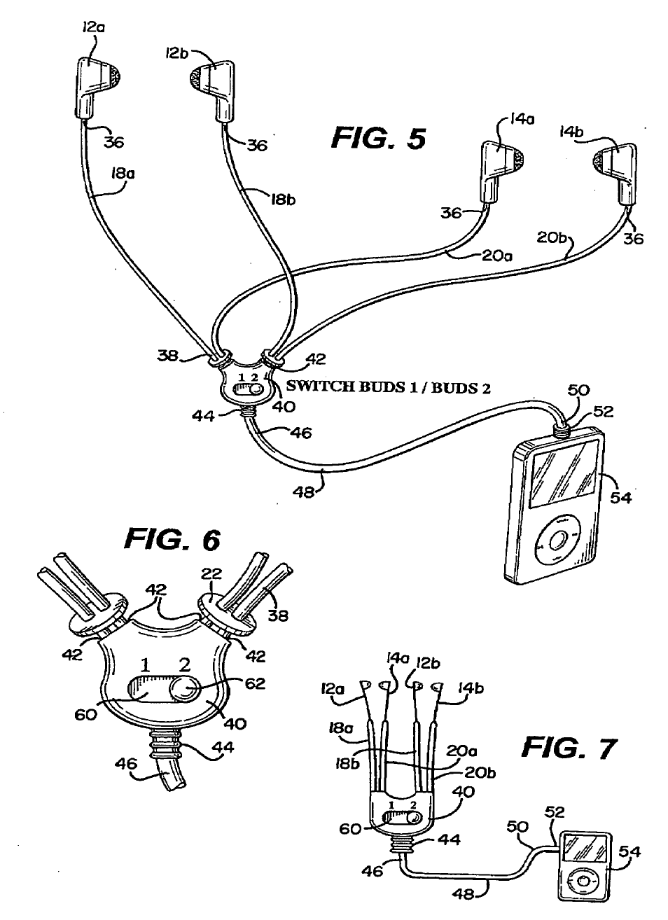

It is also contemplated that the system 10 can have numerous configurations in addition to those shown in FIGS. 1-4. For example, another preferred form of the invention includes a three-bud headphone system having a single earbud assembly electrically coupled to a solitary earbud. The earbud assembly has a primary earbud and a secondary earbud for use in one ear when in a docked position. The solitary earbud could be used in a second ear of a user of the device or could be shared with a second person. It is also contemplated the primary earbud and the solitary earbud could be used by one user and the secondary earbud could be shared with a second user. Further, it is contemplated the three buds could be shared by three users. It is also contemplated, and will be discussed below in reference to FIGS. 5 and 6, the earbud system could be a four-earbud system with two earbud assemblies each having primary and secondary earbuds.

FIGS. 2 and 4 show another embodiment of the dual bud headphone system 10 and like numbers will refer to like parts as in FIG. 1. In this embodiment the secondary earbud 14 nests within a recess 31 in the primary earbud 12 and forms an interference or friction fit therewith so that a separate attaching member 16 is not necessary for releasably connecting the primary earbud 12 to the secondary earbud 14. The system 10 includes an optional microphone 30 that is attached to the earbud assembly 15 on the secondary earbud 14, but it could be also attached to the primary earbud 12 or elsewhere such as on or in line with one of the cords or elsewhere. In the embodiment shown in FIGS. 2 and 4 where the microphone 30 is positioned on the earbud it may be desirable for the microphone to be a boom microphone capable of being positioned with respect to a mouth of a user such as by pivoting the microphone to point it toward the user's mouth. It is contemplated that the microphone positioning option may be useful in other embodiments as well where the microphone is positioned in a location different from an earbud.

In another preferred form of the invention, the headphone system 10 includes a send/end switch 60 (FIG. 3) to allow users to answer and terminate telephone calls.

FIG. 3 shows the system of FIG. 1 in an undocked position and FIG. 4 shows the system 10 of FIG. 2 in an undocked position.

FIG. 5 shows the dual bud headphone system 10 in an undocked position with two primary earbuds 12a,b and two secondary earbuds 14a,b, and each earbud having an associated cord 18a,b and 20a,b. In this position the two primary earbuds 12a,b could be used by a first person or a first couple of people and the secondary earbuds 14a,b could be used by a second person or a first couple or a second couple of people. A first end 36 of each of the cords is connected to an earbud and a second end 38 is connected to a bus 40. The first end 36 can include a pivotable connector for enhanced positioning of the earbuds. The bus 40 has four electrical output receptacles 42 for individually receiving the second end 38 of each of the four cords. The bus 40 also has at least one input electrical receptacle 44 for receiving a first end 46 of an input line 48. A second end 50 of the input line 48 has a member 52 for electrically connecting to a signal source 54. Thus, the bus 40 places the signal source 54 into electrical communication with the primary and secondary earbuds 12, 14.

As shown in FIGS. 5 and 6, the bus 40 has an optional switch 60 with a toggle member 62 for moving the switch from a first position when the system is in a docked position and being used by a single wearer, to a second position when the system is in an undocked position for use with two or more wearers. It is further contemplated the self-contained dual bud headphone system 10 could include a single volume control or separate volume controls positioned on the bus or elsewhere allowing users to individually adjust the volume levels of each pair of earbuds or each bud individually.

FIG. 7 shows the dual bud headphone system 10 in an undocked position similar to FIG. 5 except that one primary earbud 12 and one secondary earbud 14 are positioned for use by a first person or a first couple of people and the second primary earbud 12b and the second secondary earbud 14b are positioned for use by a second person or a first or second couple of people.

FIGS. 8a,b,c show the dual bud headphone system 10 on the head 75 of a user having a wireless connection 72 between the signal source 54 and the primary earbud 12a. FIG. 8a shows the earbud assembly 15, secondary earbud docked to the primary earbud, positioned in a single ear of the user and FIG. 8b shows the system in an undocked position with the primary earbud 12 in one ear and the secondary earbud 14 in the opposite ear. The secondary earbud 14 receives a wireless signal 74 from the primary earbud 12 (FIG. 8b) or from the signal source 54 (FIG. 8c). Thus, with a single dual bud headphone system 10 shown in FIGS. 8,b,c, one person could use the primary and secondary earbuds docked together in one ear for monaural listening, in an undocked position with the primary earbud in one ear and the secondary earbud in the second ear for stereo listening or binaural listening, or the system could be shared with another person with each person having one earbud in a single ear.

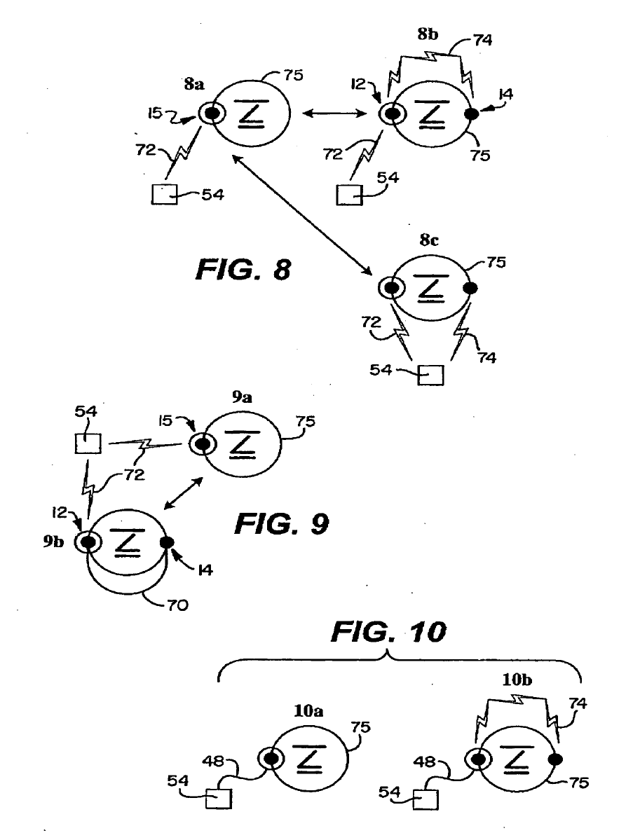

FIGS. 9a,b show the dual bud headphone system 10 having a wireless connection 74 between the signal source 54 and the primary earbud 12a and a corded connection 70 between the primary earbud 12 and the secondary earbud 14. FIG. 9a shows the system in a docked position and FIG. 9b shows the system in an undocked position. This system can also be used by a single person in a docked and an undocked position or shared by two people in an undocked position.

FIGS. 10a,b show the dual bud headphone system 10, respectively in docked and undocked positions, having a corded connection 48 between the signal source 54 and the primary earbud 12 and a wireless connection 74 between the primary earbud 12 and the secondary earbud 14. This system can also be used by a single person in a docked and an undocked position or shared by two people in an undocked position.

The signal source 54 can emanate from any device capable of generating or conveying an electric output representative of an audible sound, and more preferably includes portable and non-portable audio or audio/video devices. Suitable devices include, but are not limited to, cell phones, computers, walkie talkies, portable audio systems such as MP3 players, IPODs, Walkman, CD players, DVD players, laser disk players radios, tape players of all types including, but not limited to, cassette, DAT, reel-to-reel, VHS, Beta, 8 track tapes, and other sources capable of generating or transmitting a signal that can be processed into an audible sound.

The wireless connection can be achieved using a device such as a blue tooth device, 802.11 device or any of the other short-distance wireless communication devices known to those skilled in the art.

It is contemplated from the above-description the self-contained dual bud headphone system 10 can have numerous configurations including: (1) a single earphone assembly having primary and secondary earbuds each having a corded connection to a signal source; (2) a single earphone assembly having primary and secondary earbuds each with a wireless connection to a signal source; (3) a single earphone assembly having primary and secondary earbuds with a wireless connection between the primary earbud and the signal source and a wireless connection between the primary earbud and the secondary earbud; (4) a single earphone assembly having primary and secondary earbuds with a wireless connection between the primary earbud and the signal source and a corded connection between the primary earbud and the secondary earbud, (5) a three-earbud system having a first earphone assembly of a first primary and a secondary earbud (capable of docking together and undocking) having a corded or wireless connection to a signal source and a second solitary earbud (mono) connected to a signal source either through a corded or wireless connection to the signal source or the first earphone assembly, (6) a first earphone assembly of a first primary earbud and a first secondary earbud and a second earphone assembly of a second primary earbud and a second secondary earbud, connected to the each other and the signal source through a corded, wireless or a combination of corded and wireless connections.

The dual bud headphone systems 10 are versatile for use by one or more people simultaneously to listen to an audible sound or sounds from virtually any source capable of generating a signal that can be processed into an audible sound. It also allows for two or three way communication with two or more people using a single telephone, walkie talkie or other communication device, without the use of a speakerphone.

Any of these configurations can be provided, where appropriate, with a send/end switch to answer and terminate calls, a switch to turn on and off the second earphone assembly (or second primary earphone), one or more microphones, and separate volume controls.

It should be understood that the present invention contemplates systems using earphones other than earbud type earphone and include earphones that are pressed or are otherwise held against a portion of the ear or that cover the entire ear or that extend into a portion of an outer ear canal of a user. It is also contemplated using headphones which attach to the head of a user using head bands and earloops (behind the head, over the head and over the ear).

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims

I claim:

1. An earphone system comprising:
a first primary earphone having a portion for contacting a portion of an ear of a user;
a first secondary earphone releasably connected to the primary earphone to define a first earphone assembly, the first secondary earphone having a portion for contacting a portion of an ear of a user; and
a member for electrically connecting the primary earphone and the secondary earphone to a source of an electrical signal representative of an audible sound.

2. The earphone system of claim 1 wherein the primary earphone and the secondary earphone are each earbud type earphones.

3. The earphone system of claim 2 further comprising an attaching member associated with the primary earbud or the secondary earbud for releasably connecting the primary earbud to the secondary earbud.

4. The earphone system of claim 1 further comprising a second primary earphone.

5. The earphone system of claim 4 further comprising a second secondary earphone releasably connected to the second primary earphone to define a second earphone assembly, the second earphone assembly in electrical communication with the source of the electrical signal.

6. The earphone system of claim 5 wherein the first earphone assembly is for use with a first user and the second earphone assembly is for use with a second user.

7. The earphone system of claim 4 further comprising a switch moveable from a first position where the electrical signal is only provided to the first earphone assembly and a second position where the electrical signal is provided to both the first earphone assembly and the second primary earphone.

8. The earphone system of claim 5 further comprising a switch moveable from a first position where the electrical signal is only provided to the first earphone assembly and a second position where the electrical signal is provided to both the first earphone assembly and the second earphone assembly.

9. The earphone system of claim 1 further comprising a switch for receiving a telephone call and for terminating a telephone call.

10. The earphone system of claim 1 wherein the source of the electrical signal emanates from a device selected from the group consisting of cell phones, computers, walkie talkies, MP3 players, IPODs, Walkman, CD players, DVD players, laser disk players, radios, tape players, cassette tape player, DAT tape player, reel-to-reel tape player, VHS tape player, Beta tape player, and 8 track tape player.

11. The system of claim 4 further comprising a control for separately controlling the volume of the first earphone assembly from the second primary earphone.

12. The system of claim 1 wherein the electrical connection is by a corded connection, a wireless connection or a combination of a corded connection and a wireless connection.
